(19) United States
(12) Patent Application Publication
(10) Pub. No.: US 2026/0112205 A1
(43) Pub. Date: Apr. 23, 2026

(54) SIGN LANGUAGE RECOGNITION METHOD AND APPARATUS

(71) Applicant: Alipay (Hangzhou) Digital Service Technology Co., Ltd., Hangzhou (CN)

(72) Inventors: Ruoyu LI, Hangzhou (CN); Dongqi TANG, Hangzhou (CN); Zhe LI, Hangzhou (CN)

(21) Appl. No.: 19/429,353

(22) Filed: Dec. 22, 2025

Related U.S. Application Data
(63) Continuation of application No. PCT/CN2024/105112, filed on Jul. 12, 2024.

(30) Foreign Application Priority Data
Jul. 13, 2023 (CN) 202310867744.2

(51) Int. Cl. G06V 40/20; G06F 40/58; G06V 10/774

(52) U.S. Cl. CPC G06V 40/28; G06F 40/58; G06V 10/774

(57) ABSTRACT

A sign language recognition method includes: obtaining a to-be-recognized video stream, where the to-be-recognized video stream includes a continuous sign language action image sequence; obtaining a hand motion posture sequence corresponding to each sign language action image sequence in the to-be-recognized video stream; inputting the to-be-recognized video stream into a pre-trained first recognition model to obtain a first recognition result, where the first recognition result includes a first probability distribution of each target word in a preset vocabulary; inputting the hand motion posture sequence into a pre-trained second recognition model to obtain a second recognition result, where the second recognition result includes a second probability distribution of each target word in the vocabulary; and determining a target text based on the first recognition result and the second recognition result.

### CROSS-REFERENCE TO RELATED APPLICATIONS

This application is a continuation application of International Application No. PCT/CN2024/105112, filed July 12, 2024, which claims priority to Chinese Patent Application No. 202310867744.2, filed on July 13, 2023, the entire contents of both of which are incorporated herein by reference.

### TECHNICAL FIELD

The present disclosure relates to the field of artificial intelligence technologies, and in particular, to a sign language recognition method and apparatus, an interaction system, and an electronic device.

### BACKGROUND

In a conventional sign language recognition solution, a visual signal is usually used as an input and text information is usually used as an output to implement translation from a visual feature sequence to a text feature sequence. However, this recognition manner depends only on the visual signal, and in a process of capturing the visual signal, an action may be difficult to recognize due to factors such as a shooting angle and a shooting action range, resulting in a problem of misrecognition or missed recognition.

### SUMMARY

An embodiment of this specification provides a sign language recognition method, including: obtaining a to-be-recognized video stream, where the to-be-recognized video stream includes a continuous sign language action image sequence; obtaining a hand motion posture sequence corresponding to each sign language action image sequence in the to-be-recognized video stream; inputting the to-be-recognized video stream into a pre-trained first recognition model to obtain a first recognition result, where the first recognition result includes a first probability distribution of each target word in a preset vocabulary; inputting the hand motion posture sequence into a pre-trained second recognition model to obtain a second recognition result, where the second recognition result includes a second probability distribution of each target word in the vocabulary; and determining a target text based on the first recognition result and the second recognition result.

An embodiment of this specification provides a sign language recognition apparatus, including: a processor; and a memory storing instructions executable by the processor. The processor is configured to: obtain a to-be-recognized video stream, where the to-be-recognized video stream includes a continuous sign language action image sequence; obtain a hand motion posture sequence corresponding to each sign language action sequence in the to-be-recognized video stream; input the to-be-recognized video stream into a pre-trained first recognition model to obtain a first recognition result, where the first recognition result includes a first probability distribution of each target word in a preset vocabulary; input the hand motion posture sequence into a pre-trained second recognition model to obtain a second recognition result, where the second recognition result includes a second probability distribution of each target word in the vocabulary; and determine a target text based on the first recognition result and the second recognition result.

An embodiment of this specification further provides a non-transitory computer-readable storage medium. The computer-readable storage medium stores a computer program, and when the computer program is executed by a processor, the above sign language recognition method is implemented.

### BRIEF DESCRIPTION OF DRAWINGS

The following briefly describes the accompanying drawings of this specification. Clearly, the accompanying drawings in the following descriptions show example embodiments of this specification.

FIG. 1 is a flowchart of a sign language recognition method according to an embodiment.

FIG. 2 is a flowchart of applying a sign language recognition method to a scenario according to an embodiment.

FIG. 3 is a block diagram of a sign language recognition apparatus according to an embodiment.

FIG. 4 is a block diagram of an interaction system according to an embodiment.

FIG. 5 is a block diagram of an electronic device according to an embodiment.

### DETAILED DESCRIPTION OF EMBODIMENTS

The following describes example embodiments of this specification with reference to the accompanying drawings. Clearly, the described embodiments are merely some examples but not all of the embodiments of this specification. Therefore, it should be understood by a person of ordinary skill in the art that various changes and modifications can be made to the embodiments described herein without departing from the scope and spirit of this specification.

It should be noted that steps of the described method are not necessarily performed in the sequence shown and described in this specification. In some embodiments, the method can include more or fewer steps than those described in this specification. In addition, a single step described in this specification may be split into a plurality of steps, and a plurality of steps described in this specification may be combined into a single step.

People with hearing impairments are an important part of the world's population. To make it more convenient for the people with hearing impairments to live in all aspects, various industries are making efforts. A sign language is an indispensable communication tool in daily life for the people with hearing impairments. Technologies such as sign language recognition and translation provide great convenience for communication between the people with hearing impairments and others by converting sign language actions into corresponding sentence texts. However, a shooting angle and an action range of the sign language action may make it difficult to recognize the sign language action, resulting in a problem of misrecognition or missed recognition. If a visual signal corresponding to the sign language action is used as an input to implement translation from a visual feature sequence to a text feature sequence, a problem that may occur in a process of capturing the sign language action affects accuracy of a recognition result.

Therefore, this specification provides a new sign language recognition solution. Based on extraction of a visual feature of a sign language action, motion posture data of the sign language action is introduced for calibration, for example, hand sensor data, thereby effectively improving sign language recognition accuracy.

The following describes in detail the sign language recognition method and apparatus in the embodiments of this specification with reference to the accompanying drawings. However, the detailed descriptions constitute no limitation on the embodiments of this specification.

It should be noted that the terms used in the embodiments of this specification are merely used to describe specific embodiments, and are not intended to limit this specification. The terms "a", "an", and "the" of singular forms used in the embodiments and the appended claims are intended to include plural forms, unless otherwise specified in the context clearly.

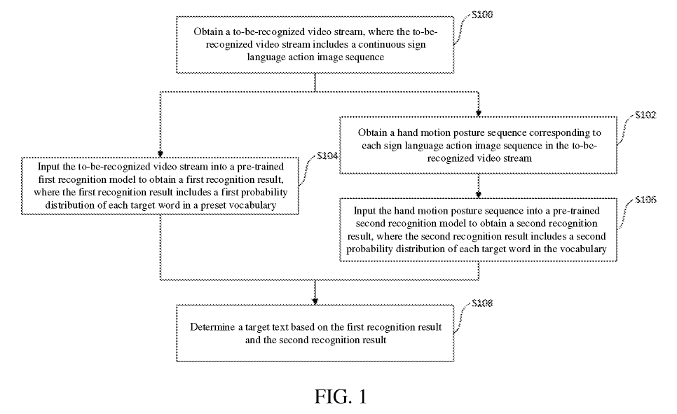

FIG. 1 is a flowchart of a sign language recognition method according to an embodiment. As shown in FIG. 1, the method includes the following steps.

S100: Obtain a to-be-recognized video stream, where the to-be-recognized video stream includes a continuous sign language action image sequence.

A to-be-recognized sign language video can be shot by using a device having an image capture function, for example, a mobile phone, a camera, or a video camera, and the obtained to-be-recognized video stream is transmitted to a specified location for sign language recognition, for example, through wired transmission or network transmission.

The to-be-recognized video stream is a sign language action video. In sign language expression, a commonly used word is expressed by a specific sign language action, which can be a still hand action or a continuous hand action. Therefore, the to-be-recognized video stream is divided into several continuous hand action image sequences. Each sign language action image sequence corresponds to one translated word, the translated word is a natural language word, and a language type is not limited. All sign language action image sequences constitute the to-be-recognized video, and all corresponding translated words constitute a target statement text.

S102: Obtain a hand motion posture sequence corresponding to each sign language action image sequence in the to-be-recognized video stream.

In some embodiments, the hand motion posture sequence corresponding to the sign language action can be obtained by using a sensor disposed on a hand, for example, a gyroscope or an accelerometer. When a location or a posture of the hand changes, the corresponding sensor captures the change, and reflects this in sensor data. Therefore, the hand motion posture sequence can include sensor data, for example, gyroscope data or accelerometer data.

S104: Input the to-be-recognized video stream into a pre-trained first recognition model to obtain a first recognition result, where the first recognition result includes a first probability distribution of each target word in a preset vocabulary.

In some embodiments, the first recognition model can be constructed based on an encoder-decoder structure. The to-be-recognized video stream that includes at least one continuous sign language action image sequence is input into an encoder in the first recognition model for encoding, and a visual feature corresponding to each sign language action image sequence is separately extracted, where each sign language action image sequence is translated and then corresponds to one word; and then the visual feature corresponding to each sign language action image sequence is separately decoded by using a decoder to predict a sign language action translation result, to obtain, as the first probability distribution, a probability distribution of each word in the preset vocabulary being a target word corresponding to the sign language action, so as to obtain the first recognition result.

The preset vocabulary records target words that can be expressed by using sign language actions, including but not limited to common greetings such as thanks and goodbye, commonly used pronouns such as you, me, and him, and nouns.

In some embodiments, the first recognition model can be constructed based on a transformer network structure, and the encoder and the decoder in the first recognition model can also use transformer networks.

In some embodiments, the first recognition model is obtained through pre-training in the following manner: obtaining a sample video stream, where the sample video stream includes a continuous sign language action image sequence sample; determining a first text corresponding to the sign language action image sequence sample, and using the first text as a first label of the sample video stream; and training the first recognition model based on the sample video stream and the first label until the first recognition model that satisfies a preset stop condition is obtained.

The sample video stream includes at least one continuous sign language action image sequence sample, and each sign language action image sequence sample represents a complete word. A corresponding word is combined to obtain the first text corresponding to the sample video stream, that is, a meaning expressed by a sign language action in the sample video stream is described in a text form, and then the first text is used as a real label of the sample video stream. The sample video stream is input into the first recognition model, encoding and decoding are performed to obtain the first recognition result, a first recognition loss is determined by calculating a difference between the first recognition result and the first label, and the first recognition model is trained with an objective of minimizing the recognition loss.

In some embodiments, a loss function of the first recognition loss can be a total probability distribution difference. That is, a difference between a probability distribution predicted by the first recognition model for each sign language action image sequence sample in the sample video stream and that of a corresponding word in the first text is separately calculated, and then a sum of all calculated differences is determined as the first recognition loss. For example, if there are a total of 10 words in the first text, when the loss function is calculated, for each word, a difference between a probability distribution of the word and a probability distribution of the word predicted by the first recognition model for a corresponding sign language action image sequence can be first calculated, and then a sum of differences in probability distributions of the 10 words can be calculated to obtain the first recognition loss.

An input to the first recognition model is a to-be-recognized sign language action video, and an output is a corresponding sign language recognition text. The to-be-recognized video stream is divided into at least one continuous sign language action image sequence, encoding and decoding are performed, and each independent sign language action is translated and output, to implement word-by-word recognition.

In some embodiments, the inputting the to-be-recognized video stream into the pre-trained first recognition model to obtain the first recognition result includes: when determining a prediction result of the first recognition model for a current target word, using determined text content in the target text as a first auxiliary input to the first recognition model; and determining the prediction result of the first recognition model for the current target word based on the first auxiliary input and a current hand action image sequence.

When sign language recognition is performed by using the first recognition model, there is word-by-word output. Therefore, when a second word and a subsequent word are recognized, a probability distribution of a recognized word can be input together with a hand action image sequence into the first recognition model, to assist prediction of a subsequent word, and obtain a more accurate and proper sign language recognition result with reference to context information.

S106: Input the hand motion posture sequence into a pre-trained second recognition model to obtain a second recognition result, where the second recognition result includes a second probability distribution of each target word in the vocabulary.

In some embodiments, the second recognition model can be constructed based on an encoder-decoder structure. The hand motion posture sequence captured by using the sensor is input into an encoder in the second recognition model for encoding, and a hand motion feature corresponding to each hand motion posture sequence is separately extracted, where each hand motion posture sequence corresponds to one sign language action, and correspondingly corresponds to one word expressed by using the sign language action; and then the hand motion feature corresponding to each hand motion posture sequence is separately decoded by using a decoder to predict a sign language action translation result, to obtain, as the second probability distribution, a probability distribution of each word in the preset vocabulary being a target word corresponding to the sign language action, so as to obtain the second recognition result.

For inaccurate or incomplete sign language action information recognition caused due to a problem such as a sign language video shooting angle or a sign language action range, hand motion posture data is introduced for supplementation, to alleviate a problem of misrecognition or missed recognition, and improve sign language recognition accuracy.

In some embodiments, the second recognition model can be constructed based on a transformer network structure, and the encoder and the decoder in the second recognition model can also use transformer networks.

In some embodiments, the second recognition model is obtained through pre-training in the following manner: determining a second text; obtaining a hand motion posture sequence sample for performing a sign language action corresponding to the second text; using the second text as a second label of the hand motion posture sequence sample; and training the second model based on the hand motion posture sequence sample and the second label until the second recognition model that satisfies a preset stop condition is obtained.

When a sample is obtained, a second text used as a real label needs to be first determined, and then a hand motion posture sequence for expressing content in the second text by using a sign language is captured as a training sample by using a tool such as a sensor, and each word in the second text corresponds to one hand motion posture sequence sample. The hand motion posture sequence sample is input into the second recognition model, encoding and decoding are performed to obtain the second recognition result, a second recognition loss is determined by calculating a difference between the second recognition result and the second label, and the second recognition model is trained with an objective of minimizing the recognition loss.

In some embodiments, a loss function of the second recognition loss can be a total probability distribution difference. That is, a difference between a probability distribution predicted by the second recognition model for each hand motion posture sequence sample and that of a corresponding word in the second text is separately calculated, and then a sum of all calculated differences is determined as the second recognition loss.

An input to the second recognition model is a hand motion posture sequence, and an output is a corresponding sign language recognition text. After the hand motion posture sequence representing each sign language action is separately encoded and decoded, each independent sign language action is translated and output, to implement word-by-word recognition.

In some embodiments, the inputting the hand motion posture data into the pre-trained second recognition model to obtain the second recognition result includes: when determining a prediction result of the second recognition model for a current target word, using determined text content in the target text as a second auxiliary input to the second recognition model; and determining the prediction result of the second recognition model for the current target word based on the second auxiliary input and a current hand motion posture sequence.

When sign language recognition is performed by using the second recognition model, there is word-by-word output. Therefore, when a second word and a subsequent word are recognized, a probability distribution of a recognized word can be input together with a hand motion posture sequence sample into the second recognition model, to assist prediction of a subsequent word, and obtain a more accurate and proper sign language recognition result with reference to context information.

S108: Determine a target text based on the first recognition result and the second recognition result.

The target text is a word or a statement obtained after a sign language action in the to-be-recognized video stream is translated, and is a natural language word, and a language type is not limited.

In some embodiments, the determining the target text based on the first recognition result and the second recognition result includes: for each target word in the target text, obtaining a first probability distribution of the target word predicted by the first recognition model, and obtaining a second probability distribution of the target word predicted by the second recognition model; performing weighted summation on the first probability distribution and the second probability distribution of the target word to obtain a third probability distribution of the target word; and determining the target word from the vocabulary based on the third probability distribution of the target word.

Because both the first recognition model and the second recognition model can perform word-by-word recognition and output, each of the first recognition result and the second recognition result includes a probability distribution of each target word. The first recognition result is obtained based on a visual feature of a sign language action. The visual feature of the sign language action is a main basis for understanding a sign language meaning during communication by using a sign language, and should be more important than a hand motion feature. Therefore, in some embodiments, when weighted summation is performed on the first probability distribution and the second probability distribution of the target word, a higher weight is allocated to the first probability distribution based on the visual feature, and a lower weight is allocated to the second probability distribution based on the hand motion feature, so that the first recognition model performs a main function, and the second recognition model performs a fine-tuning function.

After the third probability distribution is obtained based on the first probability distribution and the second probability distribution of the target word, a predicted word with a highest probability is selected from the preset vocabulary as the target word.

Sign language recognition is performed by supplementing hand motion posture data. This can effectively compensate for a lack of a visual feature in a sign language action capture process, for example, misrecognition or missed recognition, implement decoupling between visual data and motion posture data, and improve sign language recognition accuracy and recognition efficiency.

According to the sign language recognition method provided in this embodiment of this specification, a sign language action image sequence is used to obtain a visual feature of a sign language, and a sign language motion posture sequence is introduced to obtain a hand motion feature. Then, weighting is performed with reference to sign language recognition results obtained based on the two sign language features, to obtain a corresponding target text. This helps effectively supplement data for problems of misrecognition and missed recognition caused due to an improper shooting angle or action range, and implement decoupling between visual data and motion posture data, to implement lightweight sign language recognition. In addition, a determined word in the target text is used as an auxiliary input, so that context information can be considered into a sign language recognition process to obtain a more accurate recognition result.

The following further describes the sign language recognition method, by using an application of the sign language recognition method to a scenario as an example. However, the descriptions constitute no limitation on the embodiments of this specification.

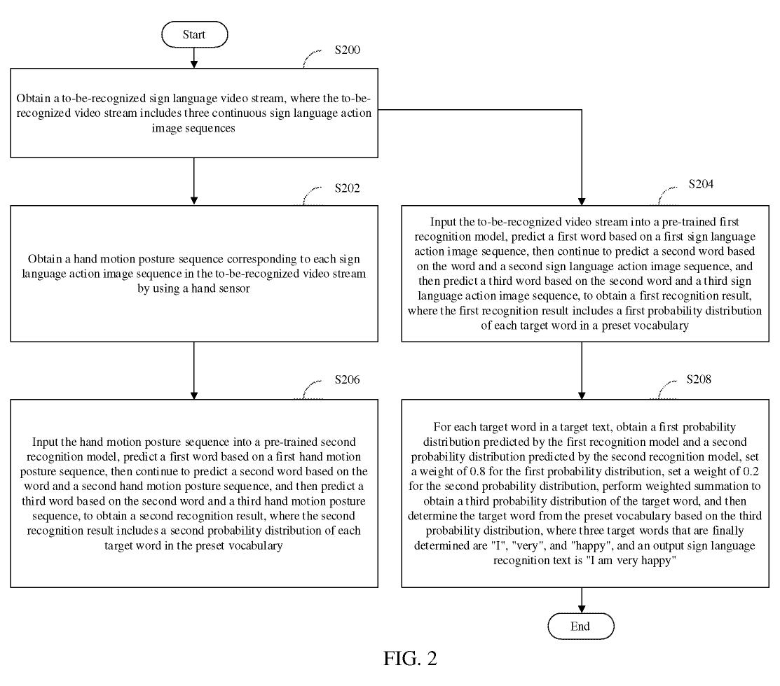

FIG. 2 is a flowchart of applying a sign language recognition method to a scenario according to an embodiment. As shown in FIG. 2, the sign language recognition method includes the following steps.

S200: Obtain a to-be-recognized sign language video stream, where the to-be-recognized video stream includes three continuous sign language action image sequences.

S202: Obtain a hand motion posture sequence corresponding to each sign language action image sequence in the to-be-recognized video stream by using a hand sensor.

S204: Input the to-be-recognized video stream into a pre-trained first recognition model, predict a first word based on a first sign language action image sequence, then continue to predict a second word based on the word and a second sign language action image sequence, and then predict a third word based on the second word and a third sign language action image sequence, to obtain a first recognition result, where the first recognition result includes a first probability distribution of each target word in a preset vocabulary.

S206: Input the hand motion posture sequence into a pre-trained second recognition model, predict a first word based on a first hand motion posture sequence, then continue to predict a second word based on the word and a second hand motion posture sequence, and then predict a third word based on the second word and a third hand motion posture sequence, to obtain a second recognition result, where the second recognition result includes a second probability distribution of each target word in the preset vocabulary.

S208: For each target word in a target text, obtain a first probability distribution predicted by the first recognition model and a second probability distribution predicted by the second recognition model, set a weight of 0.8 for the first probability distribution, set a weight of 0.2 for the second probability distribution, perform weighted summation to obtain a third probability distribution of the target word, and then determine the target word from the preset vocabulary based on the third probability distribution, where three target words that are finally determined are "I", "very", and "happy", and an output sign language recognition text is "I am very happy".

In another embodiment, the to-be-recognized video stream and the corresponding hand motion posture sequence can be concatenated and then input together into a pre-trained third recognition model to obtain a third recognition result, and a target text is determined based on the third recognition result, to implement multimodal sign language recognition.

In some embodiments, the third recognition model can use a transformer-based encoder-decoder network structure, and both an encoder and a decoder can be constructed based on the transformer. The to-be-recognized video stream and the corresponding hand motion posture sequence are input into the encoder, a visual feature of each sign language action and a corresponding hand motion feature are separately extracted, and the two features are fused to obtain a fused feature of the sign language action. The fused feature is input into the decoder for prediction, to obtain a probability distribution of each word in the preset vocabulary being a target word corresponding to the sign language action, so as to obtain the third recognition result and output a sign language recognition text.

The third recognition model can be obtained through pre-training in the following manner: obtaining a sample video stream, where the sample video stream includes a continuous sign language action image sequence sample; determining a third text corresponding to the sign language action image sequence sample, and using the third text as a third label of the sample video stream; obtaining a hand motion posture sequence sample for performing a sign language action corresponding to the third text; inputting the sample video stream and the corresponding hand motion posture sequence sample into the third recognition model to obtain a sign language prediction result; and training the third recognition model based on the sign language prediction result and the third label until the third recognition model that satisfies a preset stop condition is obtained.

The third recognition model is trained with an objective of minimizing a difference between the sign language prediction result and the third label.

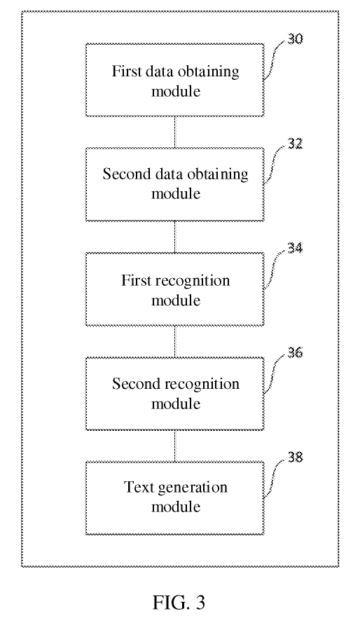

FIG. 3 is a block diagram of a sign language recognition apparatus according to an embodiment. As shown in FIG. 3, the sign language recognition apparatus includes: a first data obtaining module 30, configured to obtain a to-be-recognized video stream, where the to-be-recognized video stream includes a continuous sign language action image sequence; a second data obtaining module 32, configured to obtain a hand motion posture sequence corresponding to each sign language action sequence in the to-be-recognized video stream; a first recognition module 34, configured to input the to-be-recognized video stream into a pre-trained first recognition model to obtain a first recognition result, where the first recognition result includes a first probability distribution of each target word in a preset vocabulary; a second recognition module 36, configured to input the hand motion posture sequence into a pre-trained second recognition model to obtain a second recognition result, where the second recognition result includes a second probability distribution of each target word in the vocabulary; and a text generation module 38, configured to determine a target text based on the first recognition result and the second recognition result.

The first data obtaining module 30 can shoot the to-be-recognized sign language video by using a device having an image capture function, for example, a mobile phone, a camera, or a video camera, and transmit the obtained to-be-recognized video stream to a specified location for sign language recognition, for example, through wired transmission or network transmission.

The to-be-recognized video stream is a sign language action video. In sign language expression, a commonly used word is expressed by a specific sign language action, which can be a still hand action or a continuous hand action. Therefore, the to-be-recognized video stream is divided into several continuous hand action image sequences. Each sign language action image sequence corresponds to one translated word, the translated word is a natural language word, and a language type is not limited. All sign language action image sequences constitute the to-be-recognized video, and all corresponding translated words constitute a target statement text.

In some embodiments, the second data obtaining module 32 can obtain the hand motion posture sequence corresponding to the sign language action by using a sensor disposed on a hand, for example, a gyroscope or an accelerometer. When a location or a posture of the hand changes, the corresponding sensor captures the change, and reflects this in sensor data. Therefore, the hand motion posture sequence can include sensor data, for example, gyroscope data or accelerometer data.

In some embodiments, the first recognition model 34 includes: a first encoder, configured to perform feature extraction on the sign language action image sequence in the to-be-recognized video stream to obtain a visual feature; and a first classifier, configured to classify the visual feature to obtain the first recognition result.

The first recognition module 34 can construct the first recognition model based on an encoder-decoder structure, and the classifier can be an encoder. The first recognition module 34 inputs the to-be-recognized video stream that includes at least one continuous sign language action image sequence into the encoder in the first recognition model for encoding, and separately extracts a visual feature corresponding to each sign language action image sequence, where each sign language action image sequence is translated and then corresponds to one word; and then separately classifies the visual feature corresponding to each sign language action image sequence by using the classifier to predict a sign language action translation result, to obtain, as the first probability distribution, a probability distribution of each word in the preset vocabulary being a target word corresponding to the sign language action, so as to obtain the first recognition result.

The preset vocabulary records target words that can be expressed by using sign language actions, including but not limited to common greetings such as thanks and goodbye, commonly used pronouns such as you, me, and him, and nouns.

In some embodiments, the first recognition model can be constructed based on a transformer network structure, and the encoder and the classifier in the first recognition model can also use transformer networks.

In some embodiments, the first recognition module 34 obtains the first recognition model through pre-training in the following manner: obtaining a sample video stream, where the sample video stream includes a continuous sign language action image sequence sample; determining a first text corresponding to the sign language action image sequence sample, and using the first text as a first label of the sample video stream; and training the first recognition model based on the sample video stream and the first label until the first recognition model that satisfies a preset stop condition is obtained.

The sample video stream includes at least one continuous sign language action image sequence sample, and each sign language action image sequence sample represents a complete word. A corresponding word is combined to obtain the first text corresponding to the sample video stream, that is, a meaning expressed by a sign language action in the sample video stream is described in a text form, and then the first text is used as a real label of the sample video stream. The first recognition module 34 inputs the sample video stream into the first recognition model, performs encoding and decoding to obtain the first recognition result, determines a first recognition loss by calculating a difference between the first recognition result and the first label, and trains the first recognition model with an objective of minimizing the recognition loss.

In some embodiments, a loss function of the first recognition loss can be a total probability distribution difference. That is, the first recognition module 34 separately calculates a difference between a probability distribution predicted by the first recognition model for each sign language action image sequence sample in the sample video stream and that of a corresponding word in the first text, and then determines a sum of all calculated differences as the first recognition loss.

An input to the first recognition model is a to-be-recognized sign language action video, and an output is a corresponding sign language recognition text. The first recognition module 34 divides the to-be-recognized video stream into at least one continuous sign language action image sequence, performs encoding and decoding, and translates and outputs each independent sign language action, to implement word-by-word recognition.

In some embodiments, the first recognition module 34 is configured to: when determining a prediction result of the first recognition model for a current target word, use determined text content in the target text as a first auxiliary input to the first recognition model; and determine the prediction result of the first recognition model for the current target word based on the first auxiliary input and a current hand action image sequence.

When the first recognition module 34 performs sign language recognition by using the first recognition model, there is word-by-word output. Therefore, when a second word and a subsequent word are recognized, a probability distribution of a recognized word can be input together with a hand action image sequence into the first recognition model, to assist prediction of a subsequent word, and obtain a more accurate and proper sign language recognition result with reference to context information.

In some embodiments, the second recognition model includes: a second encoder, configured to perform feature extraction on the hand motion posture sequence to obtain a hand motion feature; and a second classifier, configured to classify the hand motion feature to obtain the second recognition result.

The second recognition module 36 can construct the second recognition model based on an encoder-decoder structure, and the classifier can be an encoder. The second recognition module 36 inputs the hand motion posture sequence captured by using the sensor into the encoder in the second recognition model for encoding, and separately extracts a hand motion feature corresponding to each hand motion posture sequence, where each hand motion posture sequence corresponds to one sign language action, and correspondingly corresponds to one word expressed by using the sign language action; and then separately classifies the hand motion feature corresponding to each hand motion posture sequence by using the classifier to predict a sign language action translation result, to obtain, as the second probability distribution, a probability distribution of each word in the preset vocabulary being a target word corresponding to the sign language action, so as to obtain the second recognition result.

For inaccurate or incomplete sign language action information recognition caused due to a problem such as a sign language video shooting angle or a sign language action range, the second recognition module 36 introduces hand motion posture data for supplementation, to alleviate a problem of misrecognition or missed recognition, and improve sign language recognition accuracy.

In some embodiments, the second recognition model can be constructed based on a transformer network structure, and the encoder and the classifier in the second recognition model can also use transformer networks.

In some embodiments, the second recognition module 36 obtains the second recognition model through pre-training in the following manner: determining a second text; obtaining a hand motion posture sequence sample for performing a sign language action corresponding to the second text; using the second text as a second label of the hand motion posture sequence sample; and training the second model based on the hand motion posture sequence sample and the second label until the second recognition model that satisfies a preset stop condition is obtained.

When obtaining a sample, the second recognition module 36 needs to first determine a second text used as a real label, and then captures, as a training sample by using a tool such as a sensor, a hand motion posture sequence for expressing content in the second text by using a sign language, and each word in the second text corresponds to one hand motion posture sequence sample. The hand motion posture sequence sample is input into the second recognition model, encoding and decoding are performed to obtain the second recognition result, a second recognition loss is determined by calculating a difference between the second recognition result and the second label, and the second recognition model is trained with an objective of minimizing the recognition loss.

In some embodiments, a loss function of the second recognition loss can be a total probability distribution difference. That is, a difference between a probability distribution predicted by the second recognition model for each hand motion posture sequence sample and that of a corresponding word in the second text is separately calculated, and then a sum of all calculated differences is determined as the second recognition loss.

An input to the second recognition model is a hand motion posture sequence, and an output is a corresponding sign language recognition text. After separately encoding and decoding the hand motion posture sequence representing each sign language action, the second recognition module 36 translates and outputs each independent sign language action, to implement word-by-word recognition.

In some embodiments, the second recognition module 36 is configured to: when determining a prediction result of the second recognition model for a current target word, use determined text content in the target text as a second auxiliary input to the second recognition model; and determine the prediction result of the second recognition model for the current target word based on the second auxiliary input and a current hand motion posture sequence.

When sign language recognition is performed by using the second recognition model, there is word-by-word output. Therefore, when a second word and a subsequent word are recognized, a probability distribution of a recognized word can be input together with a hand motion posture sequence sample into the second recognition model, to assist prediction of a subsequent word, and obtain a more accurate and proper sign language recognition result with reference to context information.

The target text is a word or a statement obtained after a sign language action in the to-be-recognized video stream is translated, and is a natural language word, and a language type is not limited.

In some embodiments, the text generation module 38 is configured to: for each target word in the target text, obtain a first probability distribution of the target word predicted by the first recognition model, and obtain a second probability distribution of the target word predicted by the second recognition model; perform weighted summation on the first probability distribution and the second probability distribution of the target word to obtain a third probability distribution of the target word; and determine the target word from the vocabulary based on the third probability distribution of the target word.

Because both the first recognition model and the second recognition model can perform word-by-word recognition and output, each of the first recognition result and the second recognition result includes a probability distribution of each target word. The first recognition result is obtained based on a visual feature of a sign language action. The visual feature of the sign language action is a main basis for understanding a sign language meaning during communication by using a sign language, and should be more important than a hand motion feature. Therefore, in some embodiments, when performing weighted summation on the first probability distribution and the second probability distribution of the target word, the text generation module 38 allocates a higher weight to the first probability distribution based on the visual feature, and allocates a lower weight allocated to the second probability distribution based on the hand motion feature, so that the first recognition model performs a main function, and the second recognition model performs a fine-tuning function.

After obtaining the third probability distribution based on the first probability distribution and the second probability distribution of the target word, the text generation module 38 selects a predicted word with a highest probability from the preset vocabulary as the target word.

The text generation module 38 performs sign language recognition by supplementing hand motion posture data. This can effectively compensate for a lack of a visual feature in a sign language action capture process, for example, misrecognition or missed recognition, implement decoupling between visual data and motion posture data, and improve sign language recognition accuracy and recognition efficiency.

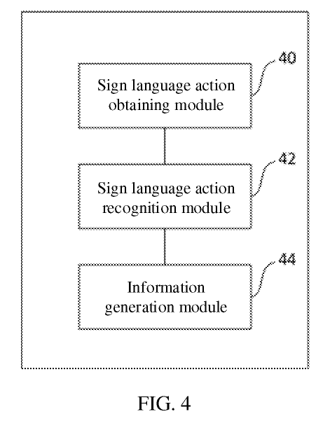

FIG. 4 is a block diagram of an interaction system according to an embodiment. As shown in FIG. 4, the interaction system includes: a sign language action obtaining module 40, configured to obtain a to-be-recognized sign language action video; a sign language action recognition module 42, configured to recognize the sign language action video based on the above sign language recognition method, to obtain a target text; and an information generation module 44, configured to: convert the target text into information of a preset type, and send information to a user.

The sign language action obtaining module 40 can shoot the to-be-recognized sign language video by using a terminal device having an image capture function, for example, a mobile phone, a camera, or a video camera, and send the obtained to-be-recognized video stream to the interaction system in a transmission manner such as wired transmission or network transmission for sign language recognition. The sign language action obtaining module 40 extracts a continuous sign language action image sequence and a corresponding hand motion posture sequence based on the sign language action video, and sends the sign language action image sequence and the corresponding hand motion posture sequence to the sign language action recognizing module. A word expressed by using each sign language action corresponds to one sign language action image sequence and one hand motion posture sequence.

The sign language action recognition module 42 recognizes the sign language action video by inputting the received sign language action image sequence and the corresponding hand motion posture sequence into any pre-trained recognition model in the above-mentioned sign language recognition method, to obtain the target text, and transmits the target text to the information generation module 44.

The information generation module 44 converts the target text into information in a form that includes but is not limited to a text of various language types, voice, and vibration, and other proper combinations, and sends the information to the user by using a terminal device such as a mobile phone or a tablet computer, to complete sign language recognition.

Embodiments of this specification further provide a non-transitory computer-readable storage medium. The computer-readable storage medium stores a computer program, and when the computer program is executed by a processor, the above sign language recognition method is implemented.

Embodiments of this specification further provide an electronic device, including: one or more processors; and a memory associated with the one or more processors. The memory is configured to store program instructions, and when the program instructions are read and executed by the one or more processors, the sign language recognition method is performed.

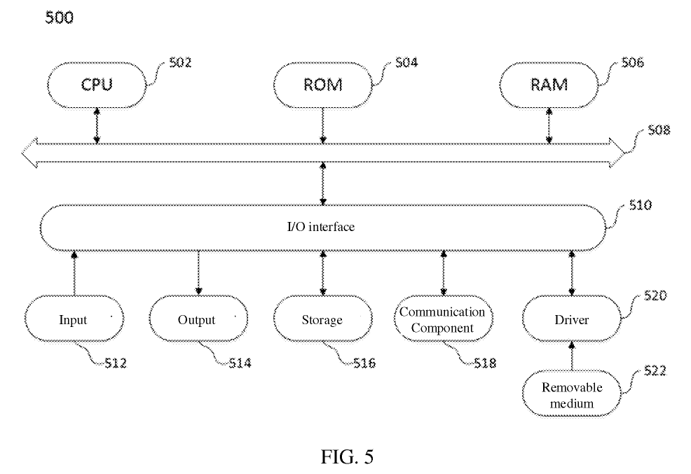

FIG. 5 is a block diagram of an electronic device 500 according to an embodiment. The device 500 is a sign language recognition apparatus, and may be implemented with a terminal device or a server. As shown in FIG. 5, the device 500 includes a processor, such as a central processing unit (CPU) 502 that can perform various proper actions and processes based on a program stored in a read-only memory (ROM) 504 or a program loaded from a storage 516 into a random access memory (RAM) 506. The RAM 506 further stores various programs and data needed for operation of the device 500. The CPU 502, the ROM 504, and the RAM 506 are connected to each other through a bus 508. An input/output (I/O) interface 510 is also connected to the bus 508.

The following parts are connected to the I/O interface 510: an input 512 including a keyboard, a mouse, etc.; an output 514 including a cathode ray tube (CRT), a liquid crystal display (LCD), a speaker, etc.; the storage 516 including a hard disk, etc.; and a communication component 518 including a network interface card such as a LAN card or a modem. The communication component 518 performs communication processing via a network such as the Internet. A driver 520 is also connected to the I/O interface 510 as needed. A removable medium 522, for example, a magnetic disk, an optical disc, a magneto-optical disc, or a semiconductor memory, is installed on the driver 520 as needed, so that a computer program read from the removable medium 522 is installed into the storage 516 as needed.

In an embodiment, a computer program for implementing the above method can be downloaded and installed from a network through communication component 518, and/or installed from the removable medium 522. When the computer program is executed by the central processing unit (CPU) 502, the above method is performed.

The non-transitory computer-readable storage medium described above can be but is not limited to an electrical, magnetic, optical, electromagnetic, infrared, or semiconductor system, apparatus, or device, or any combination thereof. More specific examples of the computer-readable storage medium can include but are not limited to an electrical connector having one or more wires, a portable computer disk, a hard disk, a random access memory (RAM), a read-only memory (ROM), an erasable programmable read-only memory (EPROM or a flash memory), an optical fiber, a compact disc read-only memory (CD-ROM), an optical storage device, a magnetic storage device, or any proper combination thereof. The computer-readable storage medium can be any tangible medium that includes or stores a program, and the program can be used by or in combination with an instruction execution system, apparatus, or device.

An embodiment of this specification provides a sign language recognition method, including: obtaining a to-be-recognized video stream, where the to-be-recognized video stream includes a continuous sign language action image sequence; obtaining a hand motion posture sequence corresponding to each sign language action image sequence in the to-be-recognized video stream; inputting the to-be-recognized video stream into a pre-trained first recognition model to obtain a first recognition result, where the first recognition result includes a first probability distribution of each target word in a preset vocabulary; inputting the hand motion posture sequence into a pre-trained second recognition model to obtain a second recognition result, where the second recognition result includes a second probability distribution of each target word in the vocabulary; and determining a target text based on the first recognition result and the second recognition result.

According to the sign language recognition method provided in this embodiment, a sign language action image sequence is used to obtain a visual feature of a sign language, and a hand motion posture sequence is introduced to obtain a hand motion feature. Then, sign language recognition results corresponding to the two sequences are separately determined, and a target text corresponding to the sign language is determined with reference to the two sign language recognition results. This can effectively supplement data for problems of misrecognition and missed recognition caused due to an improper shooting angle or action range, to obtain a more accurate sign language translation result.

Further, in some implementations, the first recognition model is obtained through pre-training in the following manner: obtaining a sample video stream, where the sample video stream includes a continuous sign language action image sequence sample; determining a first text corresponding to the sign language action image sequence sample, and using the first text as a first label of the sample video stream; and training the first recognition model based on the sample video stream and the first label until the first recognition model that satisfies a preset stop condition is obtained.

Further, in some implementations, the second recognition model is obtained through pre-training in the following manner: determining a second text; obtaining a hand motion posture sequence sample for performing a sign language action corresponding to the second text; using the second text as a second label of the hand motion posture sequence sample; and training the second model based on the hand motion posture sequence sample and the second label until the second recognition model that satisfies a preset stop condition is obtained.

Further, in some implementations, the inputting the to-be-recognized video stream into the pre-trained first recognition model to obtain the first recognition result includes: when determining a prediction result of the first recognition model for a current target word, using determined text content in the target text as a first auxiliary input to the first recognition model; and determining the prediction result of the first recognition model for the current target word based on the first auxiliary input and a current hand action image sequence.

Further, in some implementations, the inputting the hand motion posture data into the pre-trained second recognition model to obtain the second recognition result includes: when determining a prediction result of the second recognition model for a current target word, using determined text content in the target text as a second auxiliary input to the second recognition model; and determining the prediction result of the second recognition model for the current target word based on the second auxiliary input and a current hand motion posture sequence.

Further, in some implementations, the determining the target text based on the first recognition result and the second recognition result includes: for each target word in the target text, obtaining the first probability distribution of the target word predicted by the first recognition model, and obtaining the second probability distribution of the target word predicted by the second recognition model; performing weighted summation on the first probability distribution and the second probability distribution of the target word to obtain a third probability distribution of the target word; and determining the target word from the vocabulary based on the third probability distribution of the target word.

An embodiment of this specification provides a sign language recognition apparatus. According to the apparatus, relatively complete sign language recognition and relatively accurate sign language translation can be implemented with reference to a sign language video stream and a hand motion posture sequence. The sign language recognition apparatus includes: a first data obtaining module, configured to obtain a to-be-recognized video stream, where the to-be-recognized video stream includes a continuous sign language action image sequence; a second data obtaining module, configured to obtain a hand motion posture sequence corresponding to each sign language action sequence in the to-be-recognized video stream; a first recognition module, configured to input the to-be-recognized video stream into a pre-trained first recognition model to obtain a first recognition result, where the first recognition result includes a first probability distribution of each target word in a preset vocabulary; a second recognition module, configured to input the hand motion posture sequence into a pre-trained second recognition model to obtain a second recognition result, where the second recognition result includes a second probability distribution of each target word in the vocabulary; and a text generation module, configured to determine a target text based on the first recognition result and the second recognition result.

Further, in some implementations, the first recognition model includes: a first encoder, configured to perform feature extraction on the sign language action image sequence in the to-be-recognized video stream to obtain a visual feature; and a first classifier, configured to classify the visual feature to obtain the first recognition result.

Further, in some implementations, the second recognition model includes: a second encoder, configured to perform feature extraction on the hand motion posture sequence to obtain a hand motion feature; and a second classifier, configured to classify the hand motion feature to obtain the second recognition result.

An embodiment of this specification further provides an interaction system, including: a sign language action obtaining module, configured to obtain a to-be-recognized sign language action video; a sign language action recognition module, configured to recognize the sign language action video based on any step of the above-mentioned sign language recognition method, to obtain a target text; and an information generation module, configured to: convert the target text into information of a preset type, and send the information to a user.

An embodiment of this specification further provides a non-transitory computer-readable storage medium. The computer-readable storage medium stores a computer program, and when the computer program is executed by a processor, the above sign language recognition method is implemented.

An embodiment of this specification further provides an electronic device, including: one or more processors; and a memory associated with the one or more processors. The memory is configured to store program instructions, and when the program instructions are executed by the one or more processors, the above sign language recognition method is performed.

Beneficial effects of the sign language recognition method described in the embodiments of this specification are as follows: A sign language action image sequence is used to obtain a visual feature of a sign language, and a sign language motion posture sequence is introduced to obtain a hand motion feature. Then, sign language recognition results corresponding to the two sequences are separately determined, and a target text corresponding to the sign language is determined with reference to the two sign language recognition results. This can effectively supplement data for problems of misrecognition and missed recognition caused due to an improper shooting angle or action range, to implement lightweight sign language recognition. In addition, determined text content in the target text is used as an auxiliary input, so that context information can be considered into sign language recognition to obtain a more accurate recognition result.

The sign language recognition apparatus and the interaction system described in the embodiments of this specification also have the above-mentioned beneficial effects.

Example embodiments of this specification are described above. Other embodiments fall within the scope of the appended claims. In some cases, the actions or steps described in the claims can be performed in a sequence different from that in the embodiments, and the desired results can still be achieved. In addition, the process depicted in the accompanying drawings does not necessarily need a particular sequence or consecutive sequence to achieve the desired results. In some implementations, multitasking and parallel processing are feasible or may be advantageous. It should be further noted that each block in the accompanying drawings and a combination of blocks in the accompanying drawings can be implemented by a dedicated hardware-based system that performs a specified function or operation, or can be implemented by a combination of dedicated hardware and computer instructions.

It should be noted that only specific embodiments are described above. Clearly, this specification is not limited to the above embodiments. All variations directly derived or inferred by a person skilled in the art from the content disclosed in this specification shall fall within the protection scope of this specification.

1. A sign language recognition method, comprising:
obtaining a to-be-recognized video stream, wherein the to-be-recognized video stream comprises a continuous sign language action image sequence;
obtaining a hand motion posture sequence corresponding to each sign language action image sequence in the to-be-recognized video stream;
inputting the to-be-recognized video stream into a pre-trained first recognition model to obtain a first recognition result, wherein the first recognition result comprises a first probability distribution of each target word in a preset vocabulary;
inputting the hand motion posture sequence into a pre-trained second recognition model to obtain a second recognition result, wherein the second recognition result comprises a second probability distribution of each target word in the vocabulary; and
determining a target text based on the first recognition result and the second recognition result.

2. The method according to claim 1, wherein the first recognition model is obtained through pre-training in the following manner:
obtaining a sample video stream, wherein the sample video stream comprises a continuous sign language action image sequence sample;
determining a first text corresponding to the sign language action image sequence sample, and using the first text as a first label of the sample video stream; and
training the first recognition model based on the sample video stream and the first label until the first recognition model that satisfies a preset stop condition is obtained.

3. The method according to claim 1, wherein the second recognition model is obtained through pre-training in the following manner:
determining a second text;
obtaining a hand motion posture sequence sample for performing a sign language action corresponding to the second text;
using the second text as a second label of the hand motion posture sequence sample; and
training the second model based on the hand motion posture sequence sample and the second label until the second recognition model that satisfies a preset stop condition is obtained.

4. The method according to claim 1, wherein the inputting the to-be-recognized video stream into the pre-trained first recognition model to obtain the first recognition result comprises:
when determining a prediction result of the first recognition model for a current target word, using determined text content in the target text as a first auxiliary input to the first recognition model; and
determining the prediction result of the first recognition model for the current target word based on the first auxiliary input and a current hand action image sequence.

5. The method according to claim 1, wherein the inputting the hand motion posture sequence into the pre-trained second recognition model to obtain the second recognition result comprises:
when determining a prediction result of the second recognition model for a current target word, using determined text content in the target text as a second auxiliary input to the second recognition model; and
determining the prediction result of the second recognition model for the current target word based on the second auxiliary input and a current hand motion posture sequence.

6. The method according to claim 1, wherein the determining the target text based on the first recognition result and the second recognition result comprises:
for each target word in the target text, obtaining a first probability distribution of the target word predicted by the first recognition model, and obtaining a second probability distribution of the target word predicted by the second recognition model;
performing weighted summation on the first probability distribution and the second probability distribution of the target word to obtain a third probability distribution of the target word; and
determining the target word from the vocabulary based on the third probability distribution of the target word.

7. The method according to claim 1, further comprising:
converting the target text into information of a preset type; and
sending the information to a user.

8. A sign language recognition apparatus, comprising:
a processor; and
a memory storing instructions executable by the processor,
wherein the processor is configured to:
obtain a to-be-recognized video stream, wherein the to-be-recognized video stream comprises a continuous sign language action image sequence;
obtain a hand motion posture sequence corresponding to each sign language action sequence in the to-be-recognized video stream;
input the to-be-recognized video stream into a pre-trained first recognition model to obtain a first recognition result, wherein the first recognition result comprises a first probability distribution of each target word in a preset vocabulary;
input the hand motion posture sequence into a pre-trained second recognition model to obtain a second recognition result, wherein the second recognition result comprises a second probability distribution of each target word in the vocabulary; and
determine a target text based on the first recognition result and the second recognition result.

9. The apparatus according to claim 8, wherein the first recognition model comprises:
a first encoder, configured to perform feature extraction on the sign language action image sequence in the to-be-recognized video stream to obtain a visual feature; and
a first classifier, configured to classify the visual feature to obtain the first recognition result.

10. The apparatus according to claim 9, wherein the second recognition model comprises:
a second encoder, configured to perform feature extraction on the hand motion posture sequence to obtain a hand motion feature; and
a second classifier, configured to classify the hand motion feature to obtain the second recognition result.

11. The apparatus according to claim 8, wherein the first recognition model is obtained through pre-training in the following manner:
obtaining a sample video stream, wherein the sample video stream comprises a continuous sign language action image sequence sample;
determining a first text corresponding to the sign language action image sequence sample, and using the first text as a first label of the sample video stream; and
training the first recognition model based on the sample video stream and the first label until the first recognition model that satisfies a preset stop condition is obtained.

12. The apparatus according to claim 8, wherein the second recognition model is obtained through pre-training in the following manner:
determining a second text;
obtaining a hand motion posture sequence sample for performing a sign language action corresponding to the second text;
using the second text as a second label of the hand motion posture sequence sample; and
training the second model based on the hand motion posture sequence sample and the second label until the second recognition model that satisfies a preset stop condition is obtained.

13. The apparatus according to claim 8, wherein in inputting the to-be-recognized video stream into the pre-trained first recognition model to obtain the first recognition result, the processor is further configured to:
when determining a prediction result of the first recognition model for a current target word, use determined text content in the target text as a first auxiliary input to the first recognition model; and
determine the prediction result of the first recognition model for the current target word based on the first auxiliary input and a current hand action image sequence.

14. The apparatus according to claim 8, wherein in inputting the hand motion posture sequence into the pre-trained second recognition model to obtain the second recognition result, the processor is further configured to:
when determining a prediction result of the second recognition model for a current target word, use determined text content in the target text as a second auxiliary input to the second recognition model; and
determine the prediction result of the second recognition model for the current target word based on the second auxiliary input and a current hand motion posture sequence.

15. The apparatus according to claim 8, wherein in determining the target text based on the first recognition result and the second recognition result, the processor is further configured to:
for each target word in the target text, obtain a first probability distribution of the target word predicted by the first recognition model, and obtain a second probability distribution of the target word predicted by the second recognition model;
perform weighted summation on the first probability distribution and the second probability distribution of the target word to obtain a third probability distribution of the target word; and
determine the target word from the vocabulary based on the third probability distribution of the target word.

16. The apparatus according to claim 8, wherein the processor is further configured to:
convert the target text into information of a preset type; and
send the information to a user.

17. A non-transitory computer-readable storage medium storing a computer program that, when executed by a processor, cause the processor to perform a sign language recognition method, the method comprising:
obtaining a to-be-recognized video stream, wherein the to-be-recognized video stream comprises a continuous sign language action image sequence;
obtaining a hand motion posture sequence corresponding to each sign language action image sequence in the to-be-recognized video stream;
inputting the to-be-recognized video stream into a pre-trained first recognition model to obtain a first recognition result, wherein the first recognition result comprises a first probability distribution of each target word in a preset vocabulary;
inputting the hand motion posture sequence into a pre-trained second recognition model to obtain a second recognition result, wherein the second recognition result comprises a second probability distribution of each target word in the vocabulary; and
determining a target text based on the first recognition result and the second recognition result.
